(19) United States
(12) Patent Application Publication
(10) Pub. No.: US 2018/0141586 A1
(43) Pub. Date: May 24, 2018

(54) CYLINDER UNIT

(71) Applicant: SAF-HOLLAND GmbH, Bessenbach (DE)

(72) Inventor: Armin Christ, Bessenbach (DE)

(21) Appl. No.: 15/574,749

(22) PCT Filed: May 24, 2016
(86) PCT No.: PCT/EP2016/061692

§ 371 Date: Nov. 16, 2017

(30) Foreign Application Priority Data
May 29, 2015 (DE) 10 2015 108 521.6

(51) Int. Cl. B62D 7/14; F15B 20/00

(52) U.S. Cl. CPC B62D 7/144; F15B 11/0365; F15B 20/00; B62D 7/148

(57) ABSTRACT

Relates to a cylinder unit includes a rod and a housing, wherein the rod is guided on the housing so as to be displaceable along an adjustment axis, wherein a piston is fixed to the rod, which piston divides the interior space of the housing into a first chamber and a second chamber, wherein the housing has a safety outlet, and wherein the safety outlet is arranged such that the piston closes off the safety outlet in fluid-tight fashion when the rod is in a zero position.

### BACKGROUND OF THE INVENTION

The present invention relates to a cylinder unit, in particular for use in utility vehicles.

Cylinder units in particular for use in hydraulic or pneumatic systems for utility vehicles are known from the prior art. In the case of actively steered axles of a utility vehicle, preferably of a utility vehicle trailer, use is made here of cylinder units in which a piston is arranged in a housing and can, by means of a pressurized fluid, be subjected to a force in order to realize a steering movement of the wheels via a track rod or piston rod. A problem in the case of the systems known from the prior art is that, in the event of a system failure of the hydraulic system or of the pneumatic system, the required restoring movement of the wheels into a straight-ahead driving position is possible only with relatively great effort. Thus, with the present state-of-the-art, it is always necessary for a parallel safety circuit to be provided which, in the event of a system failure of the primary pneumatic or hydraulic system, acts on the steering arrangement for example in order to realize a straight-ahead driving position of the wheels. Here, in addition to the primary hydraulic assembly, further cylinder units are required in order, in the event of a system failure of one of the hydraulic systems, to nevertheless be able to return the steering assembly of the utility vehicle into a zero position. This results in a large structural space requirement, a high weight and a particularly high level of outlay in terms of control in order to be able to actuate the various safety circuits of a steering system of a utility vehicle with the corresponding signals.

It is an object of the present invention to provide a cylinder unit which has a compact design and a low weight and which simultaneously meets the requirements with regard to operational safety in the case of the cylinder unit being used in the steering system of a utility vehicle.

### SUMMARY OF THE INVENTION

According to the invention, the cylinder unit comprises a rod and a housing, wherein the rod is guided on the housing so as to be displaceable along an adjustment axis, wherein a piston is fixed to the rod, which piston divides the interior space of the cylinder into a first chamber, wherein the housing has a safety outlet, wherein the safety outlet is arranged and/or formed such that the piston closes off the safety outlet in fluid-tight fashion when the rod is in a zero position. The main components of the cylinder unit are a rod with a piston, and a housing, wherein a safety outlet is arranged on the housing such that, when the rod is situated in a zero position, the piston fixed to the rod is preferably arranged so as to close off the safety outlet in fluid-tight fashion. In the present context, a zero position of the rod is preferably defined as that position of the rod relative to the housing in which the rod ensures a straight-ahead driving position of the wheels of the utility vehicle with which the rod is preferably in engagement. Here, the safety outlet is particularly preferably provided on the housing centrally in relation to the extent of the housing along the adjustment axis, such that, when the piston is situated in the central position in the housing, said piston closes off the safety outlet in fluid-tight fashion. The feature according to the invention of a safety outlet which can be closed off in fluid-tight fashion by a piston permits a particularly simple adjustment of the return of the rod into its zero position. Thus, when the rod is situated outside the zero position and the piston is thus arranged offset with respect to the safety outlet, it is the case on one side of the piston that no fluid can escape via the safety outlet, whereas, on that side of the piston on which the safety outlet is also situated, the fluid can escape from the pressure chamber into the safety outlet. In the case of the first and the second chamber being subjected to equal pressure, this has the effect that the piston, together with the rod, reliably moves in the direction of the zero position of the rod. This movement in the direction of the zero position of the rod takes place until the piston closes off the safety outlet and thus the pressure is of the same magnitude in both chambers of the housing, because fluid can no longer escape via the safety outlet. As a result of the closure of the safety outlet by the piston, a preferably automatic hydraulic or pneumatic blockage of the rod against displacement along the adjustment axis is realized. The advantage of the very simple design of the housing with one safety outlet and one piston which closes off the safety outlet in fluid-tight fashion is that no automatic regulation system is required in order to effect an automatic restoring movement of the rod into the zero position. This feature of the present invention is suitable in particular for use in trailing steering axles or steering axles which have no steering arm offset because, owing to simple uniform pressurization of the two chambers of the housing, a restoring movement of the steered wheels of the utility vehicle into the straight-had driving position occurs without further outlay in terms of regulation. It is thus possible for cumbersome control systems for the hydraulic or pneumatic assembly to be omitted, whereby weight and costs are saved.

The safety outlet is preferably formed as an aperture in the inner wall of the housing, wherein the piston has an extent parallel to the adjustment axis, which extent is at least as great as the extent of the safety outlet parallel to the adjustment axis. The safety outlet is particularly preferably formed as a substantially circular or round aperture into the inner wall of the housing. The housing is preferably of hollow cylindrical form, wherein the piston together with the rod slides in substantially fluid-tight fashion along the inner wall of the housing. The cylinder axis of the housing is in this case preferably the adjustment axis along which the rod is guided on the housing. The piston preferably has an extent parallel to the adjustment axis, in other words a thickness, which is at least as great as the extent of the safety outlet parallel to the adjustment axis. The piston seal is particularly preferably designed for covering the safety outlet or enclosing said safety outlet between two mutually spaced-apart seals, whereby fluid is prevented from flowing from one of the two chambers into the safety outlet. In this way, the piston preferably functions, together with fluid situated in the chambers, as a steering lock.

The housing furthermore preferably has two ports, wherein the first port opens into the first chamber and the second port opens into the second chamber, wherein the safety outlet is, in relation to gravitational force, arranged preferably above or substantially opposite the ports. If, in an emergency situation, the housing is retroactively filled with a pressure medium, it is particularly preferable that ventilation of the housing is particularly straightforward if the safety outlet is situated on the top of the housing. The ventilation of the housing can be performed very easily and without further ventilation bores, and said housing can be fully filled with the corresponding fluid which effects the restoring movement of the piston together with the rod into the zero position of the rod. Here, the arrangement of the safety outlet above the ports of the housing ensures that the air situated in the housing and in the two chambers can firstly escape, and the hydraulic fluid that is preferably provided floods the first and the second chamber from below, and thus ensures a restoring movement of the rod into the zero position.

It is preferably the case that an operating fluid or a safety fluid can be introduced into the chambers via the ports. Here, in a first preferred embodiment, two chambers are provided, into which the operating fluid is introduced, which operating fluid interacts with a corresponding operating piston which is fixed to the rod. It is preferably possible, in the event of a failure or in the event of intentional deactivation of the operating hydraulics, for a safety fluid to be introduced into safety chambers which are arranged adjacent to the former chambers and in which a safety piston is arranged, in order to adjust the safety piston together with the rod back into the zero position and block said safety piston there. It is alternatively preferably possible for corresponding switching valves to be provided at the ports, which switching valves permit the inflow of the safety fluid or the inflow and outflow of the operating fluid. Here, it is particularly preferable for a strict separation between operating fluid and safety fluid to be provided in order, in particular, to satisfy the legally prescribed regulation for the parallel provision of two independent pneumatic or hydraulic circuits, and to nevertheless be able to use only a single cylinder in which both the regular drive of the longitudinal rod and of the steering system of the utility vehicle, and a restoring movement of the rod into the zero position in the event of a failure of one of the regular hydraulic or pneumatic systems, are possible.

The piston particularly preferably has two seal elements, wherein the spacing, measured parallel to the adjustment axis, of the seal elements to one another is equal to or greater than the extent of the safety outlet parallel to the adjustment axis. Here, the center spacing, that is to say the spacing of the seal elements to one another as measured in each case from the center of the seal elements in relation to the adjustment axis, is preferably regarded as a relevant spacing of the two seal elements to one another. The spacing of the seal elements is particularly preferably exactly equal to the extent of the safety outlet parallel to the adjustment axis. In this case, very exact setting of the zero position is possible, because complete sealing of the safety outlet occurs only when the piston together with the rod is situated exactly in the zero position. A greater spacing of the seal elements to one another may however be preferred if improved insensitivity of the cylinder unit to vibrations such as occur during the operation of a utility vehicle is required, and if the safety outlet should thus nevertheless remain substantially closed even in the case of relatively small deviations from the zero position for example owing to periodic vibrations. The spacing of the seal element is particularly preferably 1.05 to 1.2 times the extent of the safety outlet parallel to the adjustment axis. For this preferred range, it has been found that a good compromise between exact setting of the zero position and at the same time adequate tolerances during a movement of the piston past the safety outlet is realized.

In a preferred embodiment, the rod has a first piston and a second piston which are spaced apart from one another, wherein the first piston separates a first safety chamber and a second safety chamber from one another, wherein the second piston separates a first working chamber and a second working chamber from one another, wherein the second working chamber and the second safety chamber are separated from one another by at least one, preferably two, partition(s) of the housing. This embodiment of the cylinder unit is formed by virtue of a total of four chambers being provided in one and the same housing, of which two chambers are separated from one another by a first piston and two further pistons are separated from one another by a second piston. Here, the first piston separates the safety chambers from one another, and the second piston separates the working chambers from one another. In particular, it is possible here during normal operation of the utility vehicle and of the cylinder unit for only the first and the second working chamber to be charged with a working fluid, and for a displacement of the rod to be realized by means of the second piston and the working fluid acting on the two sides of the second piston. The safety chambers are preferably empty or are particularly preferably filled only with air, wherein the first and the second safety port and the safety outlet are preferably open for an inflow and outflow of the fluid situated in the safety chamber. If a fault occurs in the normal hydraulic system of the utility vehicle or if the steering is to be placed into a straight-ahead driving position during reverse travel of the utility vehicle, a corresponding safety fluid can be introduced into the first and into the second safety chamber, wherein the safety fluid exerts a force on the first piston such that said first piston returns the rod into its zero position and, when the zero position is reached, ultimately blocks the rod in said zero position as a result of the closure of the safety outlet. In relation to the conventional steering device known from the prior art, in which further track rods or additional cylinders are required for providing this function, the cylinder unit proposed in the present case is particularly compact, has only a very small structural space requirement, and in particular requires only very low outlay in terms of regulation for a restoring movement of the rod into the zero position. For the restoring movement, it is merely necessary for a pressurized fluid to be introduced at equal pressure into the two safety chambers, and the restoring movement of the safety piston and of the rod subsequently occurs automatically. The safety fluid may in this case particularly preferably flow into the first and the second safety chamber from a reservoir, wherein the reservoir is preferably subjected to a corresponding force by a resilient medium or for example a metallic spring in order, entirely without the use of a pump, to provide a safety fluid which is sufficient to ensure a restoring movement of the rod into the zero position.

A safety mode of the cylinder unit can preferably be produced by introducing a fluid at equal pressure into the first and into the second safety chamber, wherein the cylinder unit is designed such that the first piston is displaced in the direction of the safety outlet until it closes off the safety outlet in fluid-tight fashion. The advantage of this embodiment of the cylinder unit is that the safety mode can be produced without further regulation or control. The mere provision of a fluid with a sufficient pressure into the first and into the second safety chamber leads to a displacement of the rod into the zero position and hydraulic blockage of the rod in said position.

It is furthermore preferable for an operating mode of the cylinder unit to be characterized in that the second piston is displaced or displaceable along the adjustment axis by a fluid of the first working chamber or of the second working chamber, wherein the first and the second safety chamber are preferably empty of fluid. In the present case, “empty of fluid” preferably means filled with air or with a very low-resistance gas. Here, it is particularly preferably possible for fluid to flow into and out of the safety chambers with the least possible resistance. During normal operation of the cylinder unit, this permits operation with the least possible resistance, whereby only low losses arise in the region of the safety chambers.

The first and the second safety chamber are particularly preferably designed for being filled with compressed air. Compressed air is suitable in particular for establishing a zero position in the event of a system failure of the normal hydraulic system of a utility vehicle, because said compressed air can be drawn from the ambient air and provided for example by means of a small, relatively simple pump. In particular, if compressed air is used, further fluid accumulators are omitted, and the overall weight of the utility vehicle can be kept low.

In an alternative embodiment, a first safety port and a first working port are arranged on the housing or on the first port and open into the first chamber, wherein a second safety port and a second working port are arranged on the housing or on the second port and open into the second chamber, wherein two actuating elements are provided which block either the safety ports or the working ports. The housing thus particularly preferably has only two chambers into which two safety ports and two working ports open in parallel and independently of one another. Here, a first port which opens into the first chamber and a second port which opens into the second chamber may be provided on the housing itself, wherein the first safety port and the second working port open into the first port and the second safety port and the second working port open into the second port. Here, the structural space of the cylinder unit is particularly preferably considerably reduced, because provision is made not of two mutually adjacently arranged hydraulic or pneumatic cylinders but rather of only one cylinder, which has one first or one second chamber and one piston. Here, the actuating elements are preferably slide valves which either open the safety ports and close the working ports or open the working ports and close the safety ports.

It is preferable for each actuating element to have a restoring element which is preloaded and which acts on the actuating element such that the latter is displaced into the position in which it blocks the working port and opens up the safety port. In this way, it can be achieved that, in the event of a complete system failure on the utility vehicle, the restoring means, in the absence of a corresponding opposing force, displaces the actuating element in each case into the position in which the safety port is opened up and the working port is closed off. In this state, the safety fluid can flow in each case into the first and the second chamber, wherein, at the same time, the safety outlet is also placed into an open position, and thus an automatic restoring movement of the rod into its zero position occurs. The restoring element may particularly preferably be a spiral spring which is preloaded and which acts on the respective actuating element.

It is furthermore preferably possible for a control force which acts counter to the force of the restoring element to be applied to the actuating element, wherein, if the control force prevails, the actuating element can also be moved into the position in which it blocks the safety port and opens up the working port. In particular in the situation in which all of the systems of the utility vehicle are functioning normally, it is thus preferably the case that the actuating element is acted on by a control force which acts counter to the restoring force of the restoring element and which places the actuating element into the position in which the working port is open and the safety port is blocked. Here, the control force may preferably be applied by a piezo element or by a magnetic switch. It is furthermore preferably also possible for the control force to be provided by the normal hydraulic system, wherein, in the event of a failure of the hydraulic system and a drop in pressure in the hydraulic system, the control force drops and, ultimately, the restoring force of the restoring element prevails and moves the actuating elements into the position in which the safety ports are open and an automatic restoring movement of the rod of the cylinder unit into the zero position occurs.

It is furthermore preferably possible for the safety outlet to be closed off, wherein the safety outlet is closed off in particular when the actuating elements block the safety ports. In this embodiment of the safety outlet, the safety outlet is thus preferably closed during normal operation of the utility vehicle, wherein preferably, similarly to the restoring elements provided at the actuating elements, a valve with a restoring element is also provided at the safety outlet. The restoring element at the valve of the safety outlet advantageously acts counter to a control force which holds the safety outlet closed. If the control force decreases, for example in the event of a system failure on the utility vehicle, the restoring force of the restoring element preferably opens the safety outlet. It can be achieved in this way that, in the event of a system failure, a restoring movement of the rod of the cylinder unit into the zero position or into the zero position can occur, and thus a straight-ahead driving position of the wheels of the utility vehicle is achieved, without active control.

A blocking unit is particularly preferably provided in order to secure the rod in the zero position. In particular if the rod has been placed into a zero position hydraulically or pneumatically by means of one of the mechanisms described above, it is preferable for a blocking unit to be provided which prevents mechanical blocking of a displacement movement of the rod along the adjustment axis. This serves in particular for preventing a displacement of the rod along the adjustment axis in the event of a further pressure loss in the safety chambers, even if this is no longer possible by pneumatic or hydraulic means. Here, the blocking unit preferably has a blocking element which can be placed in engagement with a corresponding recess on the rod in order to prevent a displacement of the rod along the adjustment axis.

Here, the blocking unit is particularly preferably fixable to the housing or directly integrated at least in regions into the housing. It can be achieved in this way that the blocking unit, together with the housing, is of particularly compact form, and a functional integration both of a working cylinder and of a restoring safety cylinder and of a mechanical steering movement lock in one and the same system can be provided, without numerous separate components being required for this purpose.

### BRIEF DESCRIPTION OF THE DRAWINGS

Further advantages and features of the present invention will emerge from the following description with reference to the appended figures. Here, it is self-evident that some of the features shown in the figures may also be used in other embodiments unless this is prohibited owing to technical circumstances or has been explicitly ruled out. In the figures:

FIG. 1 shows a partially sectional view of a first preferred embodiment of the cylinder unit according to the invention;

FIG. 2 shows a sectional view of a further preferred embodiment of the cylinder unit according to the invention; and

FIG. 3 shows a further preferred embodiment of the cylinder unit according to the invention.

### DETAILED DESCRIPTION OF THE PREFERRED EMBODIMENTS

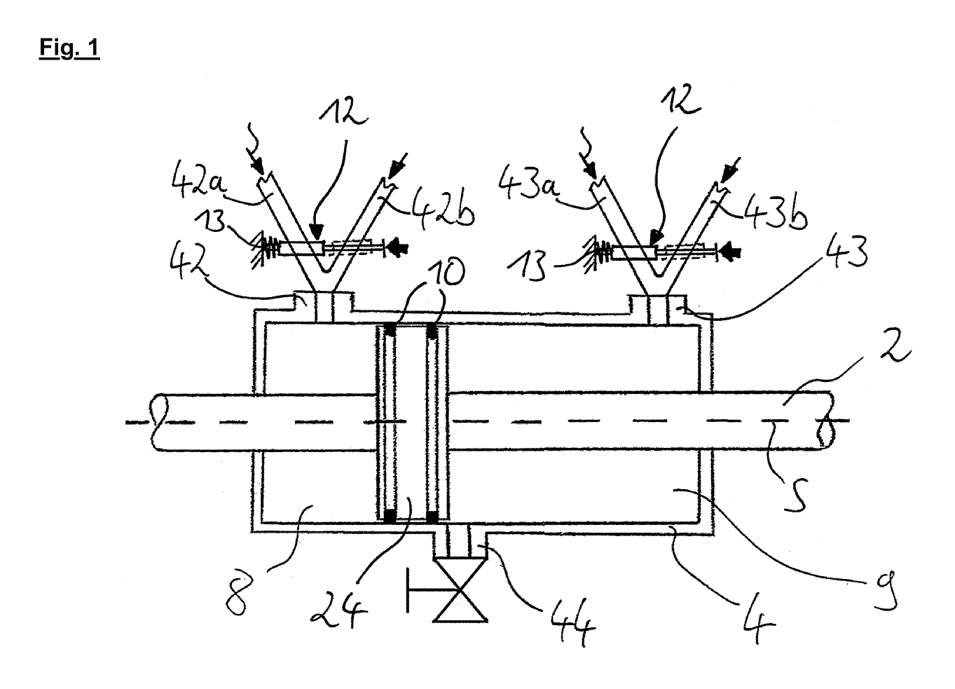

The preferred embodiment of the cylinder unit shown in FIG. 1 has a housing 4, a rod 2, and a piston 24 fixed to the rod 2. Here, the rod 2 is displaceable relative to the housing 4 along the adjustment axis S, and, at the face sides of the housing, is secured in each case against displacement transversely with respect to the adjustment axis S. Furthermore, the housing has a first port 42 and a second port 43, wherein the first port 42 opens into the first chamber 8 and the second port 43 opens into the second chamber 9. The piston 24 separates the first chamber 8 from the second chamber 9. It is furthermore preferable for a first safety port 42a and a first working port 42b to be provided on the first port 42. A second safety port 43a and a second working port 43b preferably open in at the second port 43. In the region in which the safety ports 42a, 43a and the working ports 42b, 43b open in, there is provided in each case one actuating element 12 which alternately blocks either the safety port 42a, 43a or the working port 42b, 43b and opens up the respective other port. In the embodiment illustrated, the actuating element 12 is in each case arranged such that the safety port 42a, 43a is closed off and the working port 42b, 43b is open. The state of the cylinder unit illustrated in the figure is thus the normal operating mode of the cylinder unit, in which the rod 2 can be displaced along the adjustment axis by means of an inflow and outflow of fluid into and out of the first chamber 8 and the second chamber 9. In this state, the safety outlet 44 is preferably closed off. In other words, in this state, the cylinder unit functions as a normal hydraulic or pneumatic cylinder, by means of which a steering movement at the wheels of the utility vehicle can be realized. Dashed lines in FIG. 1 illustrate the state of the actuating elements 12 in which the latter open up the safety port 42a, 43a and close off the working port 42b, 43b. In this position, a safety fluid can flow into the first chamber 8 and the second chamber 9, wherein the piston 24 is displaced along the adjustment axis S by the fluid flowing into the two chambers 8, 9 until said piston is situated exactly over the safety outlet 44 and a flow of the safety fluid out of the cylinder unit via the safety outlet 44 is prevented. Proceeding from the state shown in FIG. 1, the piston would thus be displaced to the right until it is situated exactly over the safety outlet 44 and its two seals 10 seal off the right-hand side and the left-hand side of the safety outlet 44. On the actuating elements 12, there is particularly preferably provided a restoring means 13 which is preloaded such that it seeks to displace the actuating elements 12 in the direction of the position illustrated by dashed lines. An arrow pointing counter to the action of the restoring means 13 is used to indicate a control force which is generated by the system or by a control unit of the utility vehicle during normal operation, which is at least as great as the restoring force of the restoring element 13, and which displaces the actuating element 12 in each case into the position in which the safety port 42a, 43a is closed off and the working ports 42b and 43b are in each case open.

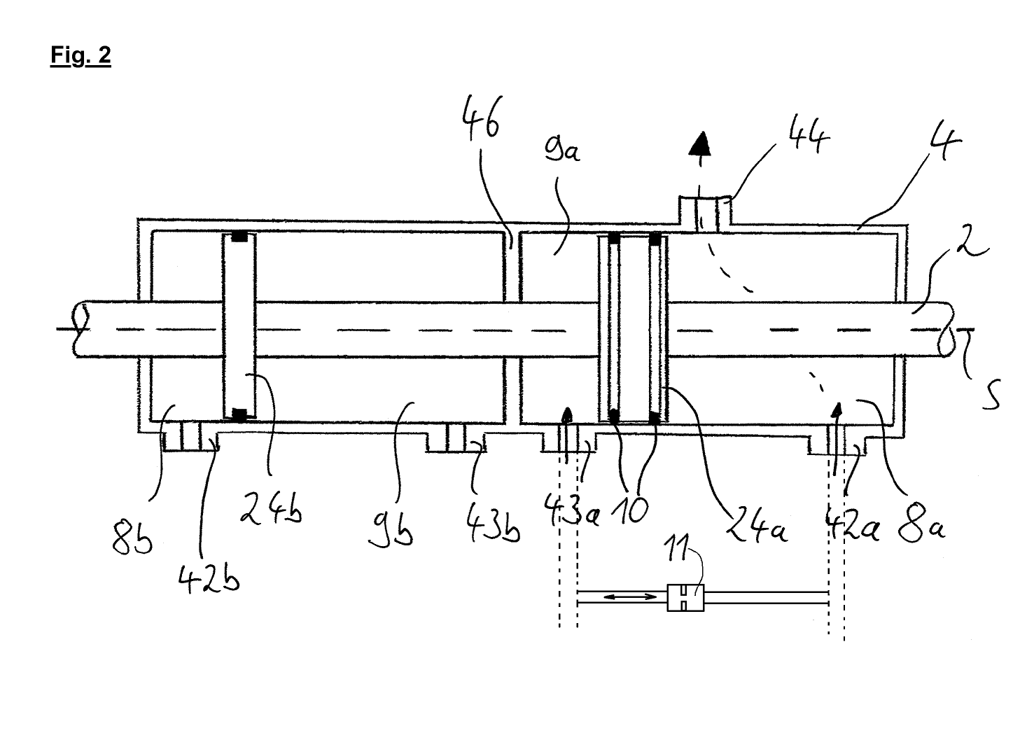

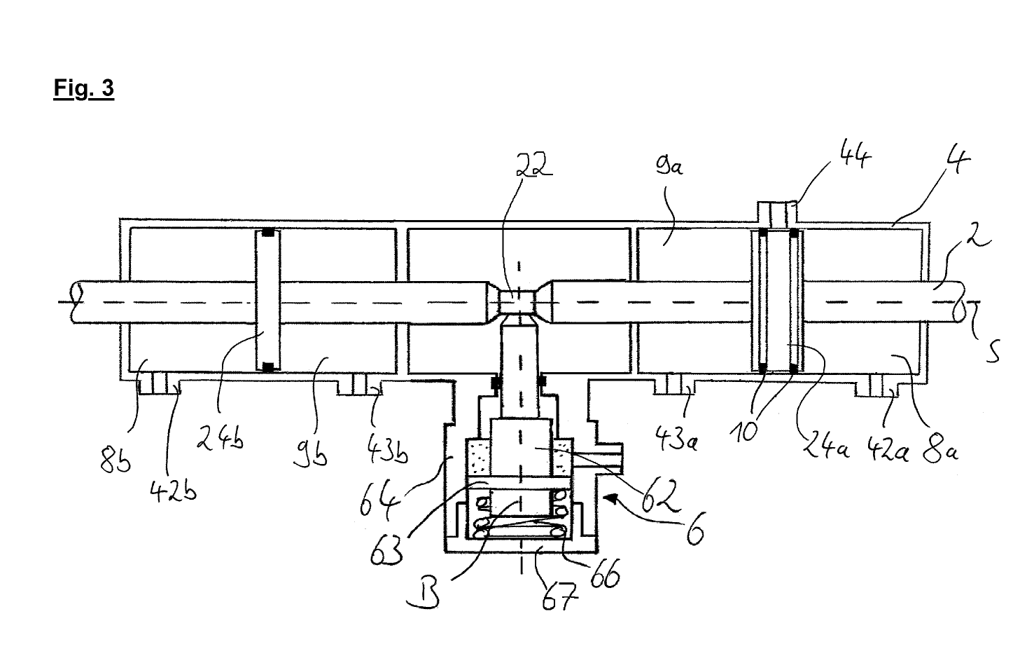

FIG. 2 shows an alternatively preferred embodiment of the cylinder unit according to the invention, wherein the working circuit and the safety circuit of the cylinder unit are preferably provided so as to be separated from one another, particularly preferably spatially separated from one another. Here, the housing 4 has the working region on the left-hand side, which working region is provided so as to be separated from the safety region of the housing 4 by a partition 46. In the safety region, it is preferable for a first safety chamber 8a and a second safety chamber 9a to be provided so as to be separated from one another by a first piston 24a. The first piston 24a has two seals 10, the spacing of which to one another is greater than the extent of the safety outlet 44 along or parallel to the adjustment axis S. Furthermore, it is preferable for a first safety port 42a to open into the first safety chamber 8a and for a second safety port 43a to open into the second safety chamber 9a. Provided on the left adjacent to the partition 46, and thus so as to be preferably entirely separated from the safety region, is a working region in which a first working chamber 8b and a second working chamber 9b are separated from one another by a second piston 24b. A first working port 42b opens into the first working chamber 8b and a second working port 43b opens into the second working chamber 9b. During normal operation, the rod 2 is preferably achieved along the adjustment axis S by means of the second piston 24b by means of an inflow and outflow of fluid into and out of the first working chamber 8b and the second working chamber 9b. If the hydraulic or pneumatic system of the utility vehicle fails and there is no longer sufficient pressure available for the pressurization of the first working chamber 8b and of the second working chamber 9b, a safety fluid is preferably introduced at equal pressure into the first safety chamber 42a and the second safety chamber 43a. Here, in the state shown in FIG. 2, a higher pressure builds up on the left-hand side of the first piston 24a in the second safety chamber 9a than in the first safety chamber 8a. For as long as the safety outlet 44 is not yet closed by the first piston 24a, it is thus possible for the fluid flowing into the first safety chamber 8a to flow out through the safety outlet 44, whereas the safety fluid flowing into the second safety chamber 9a generates a build-up of pressure therein. The pressure in the second safety chamber 9a thus exceeds the pressure in the first safety chamber 8a, and the first piston 24a performs a movement to the right. As soon as the rod 2 together with the first piston 24a is situated in the zero position, in which the first piston 24a is arranged exactly at the level of the safety outlet 44, safety fluid can no longer flow out through the safety outlet 44. As a result, the same pressure builds up in the first safety chamber 8a and in the second safety chamber 9a, whereby pneumatic or hydraulic blocking of the first piston 24 is generated. In this way, the rod 2 is hydraulically or pneumatically secured against displacement along or parallel to the pivot axis S. A damper 11 is preferably connected to the safety ports 42a, 43a, which damper is for example based on the principle of fluid friction damping. The damper 11 is preferably connected between the lines leading to the safety ports 42a, 43a, and preferably comprises an orifice. Vibrations of the rod 2 relative to the housing 4 can thus be dampened both during normal operation of the cylinder unit and during safety operation. The damper 11 is preferably equipped with a closure mechanism, preferably a shut-off valve, in order that the action of the hydraulic steering blocking is not disrupted after the closure of the safety outlet 44. A damper 11 may preferably also be used in the embodiments shown in FIGS. 1 and 3.

FIG. 3 shows an embodiment of the cylinder unit in which, in addition to the embodiment of FIG. 2, a blocking unit 6 is also provided on the housing 4, preferably in the region of the partition 46 from FIG. 2. Here, it is shown that the blocking unit 6, in a second position, prevents a displacement of the rod 2 along the adjustment axis S by means of a blocking element 62 which engages into an engagement section 22 on the rod 2. Here, said securing action is realized in addition or alternatively to blocking of the rod by means of the first piston 24a and the fluid situated in the first and the second safety chamber 8a, 9a. Furthermore, the blocking support 64 is preferably formed for the most part integrally with the housing 4. Here, only the cover 67 is screwed on after the insertion of the blocking element 62 and the restoring means 66, which simplifies the assembly process and ensures a high level of stability of the interface between housing 4 and blocking unit 6. It is self-evident that both the unipartite design and the multi-part design of said interface may be used in all other variants of the invention that are not shown here. In the second position of the blocking unit 6, the blocking element 62 is in engagement with the engagement section 22 of the rod 2. In the second state of the blocking unit 6 as shown in FIG. 3, a displacement movement of the rod 2 along the adjustment axis S relative to the housing 4 and relative to the blocking unit 6 is no longer possible. To place the blocking unit 6 into a first state again in which the blocking element 62 is not in engagement with the rod 2, the pressure of a holding means must be increased, such that the force of the holding means exceeds the restoring force of the restoring means 66, and the blocking element 62 can ultimately be disengaged from the rod 2 again.

### LIST OF REFERENCE DESIGNATIONS

2—Rod
24—Piston
24a—First piston
24b—Second piston
4—Housing
42—First port
42a—First safety port
42b—First working port
43—Second port
43a—Second safety port
43b−Second working port
44—Safety outlet
6—Blocking unit
8—First chamber
8a—First safety chamber
8b—First working chamber
9—Second chamber
9a—Second safety chamber
9b—Second working chamber
10—Seal element
11—Damper
12—Actuating element
13—Restoring element
S—Adjustment axis

1.-15. (canceled)

16. A cylinder unit, comprising:
a rod;
a housing, wherein the rod is guided on the housing so as to be displaceable along an adjustment axis; and
a piston is fixed to the rod, the piston dividing the interior space of the housing into a first chamber and a second chamber;
wherein the housing as a safety outlet that is arranged and configured such that the piston closes off the safety outlet in a fluid-tight manner when the rod is in a zero position;
wherein a first safety port and a first working port are arranged on at least one of the housing and the first port and are open into the first chamber;
wherein a second safety port and a second working port are arranged on at least one of the housing and the second port and are open into the second chamber; and
wherein two actuating elements block at least one of the safety ports and the working ports.

17. The cylinder unit as claimed in claim 16, wherein the safety outlet includes an aperture in an inner wall of the housing, and wherein the piston has an extent parallel to the adjustment axis which is at least as great as the extent of the safety outlet parallel to the adjustment axis.

18. The cylinder unit as claimed in claim 17, wherein the housing has two ports, wherein the first port opens into the first chamber and the second port opens into the second chamber, and wherein the safety outlet is arranged at least one of above and opposite the ports.

19. The cylinder unit as claimed in claim 18, wherein at least one of an operating fluid and a safety fluid can be introduced into the chambers via the ports.

20. The cylinder unit as claimed in claim 19, wherein the piston has two seal elements, wherein the spacing measured parallel to the adjustment axis of the seal elements to one another is equal to or greater than the extent of the safety outlet parallel to the adjustment axis.

21. The cylinder unit as claimed in claim 20, wherein the rod has a first piston and a second piston which are spaced apart from one another, wherein the first piston separates a first safety chamber and a second safety chamber from one another, wherein the second piston separates a first working chamber and a second working chamber from one another, and wherein the second working chamber and the second safety chamber are separated from one another by a partition of the housing.

22. The cylinder unit as claimed in claim 21, wherein a safety mode of the cylinder unit can be produced by introducing a fluid at equal pressure into the first and the second safety chamber, and wherein the first piston is designed to close off the safety outlet in fluid-tight fashion after a displacement in the direction of the safety outlet.

23. The cylinder unit as claimed in claim 21, having an operating mode where the second piston is displaceable along the adjustment axis by at least one of a fluid of the first working chamber and of the second working chamber, and wherein the first and the second safety chamber are empty of fluid.

24. The cylinder unit as claimed in claim 21, wherein the first and the second safety chamber are configured to be filled with compressed air.

25. The cylinder unit as claimed in claim 24, wherein each actuating element has a restoring element which is preloaded and which acts on the actuating element such that the restoring element is displaced into the position in which the restoring element blocks the working port and opens up the safety port.

26. The cylinder unit as claimed in claim 25, wherein a control force which acts counter to the force of the restoring element can be applied to an actuating element, and wherein, if the control force prevails, the actuating element is configured to be moved into the position in which the actuating element blocks the safety outlet and opens up the working port.

27. The cylinder unit as claimed in claim 25, wherein the safety outlet is configured to be closed off, and wherein the safety outlet is closed off when the actuating elements block the safety ports.

28. The cylinder unit as claimed in claim 27, wherein a blocking unit is provided for securing the rod in the zero position.

29. The cylinder unit as claimed in claim 28, wherein the blocking unit is at least one of fixed to the housing and integrated at least in regions into the housing.

30. The cylinder unit as claimed in claim 16, wherein the housing has two ports, wherein the first port opens into the first chamber and the second port opens into the second chamber, and wherein the safety outlet is arranged at least one of above and opposite the ports.

31. The cylinder unit as claimed in claim 30, wherein at least one of an operating fluid and a safety fluid can be introduced into the chambers via the ports.

32. The cylinder unit as claimed in claim 16, wherein the piston has two seal elements, wherein the spacing measured parallel to the adjustment axis of the seal elements to one another is equal to or greater than the extent of the safety outlet parallel to the adjustment axis.

33. The cylinder unit as claimed in claim 16, wherein the rod has a first piston and a second piston which are spaced apart from one another, wherein the first piston separates a first safety chamber and a second safety chamber from one another, wherein the second piston separates a first working chamber and a second working chamber from one another, and wherein the second working chamber and the second safety chamber are separated from one another by a partition of the housing.

34. The cylinder unit as claimed in claim 33, wherein a safety mode of the cylinder unit can be produced by introducing a fluid at equal pressure into the first and the second safety chamber, and wherein the first piston is designed to close off the safety outlet in fluid-tight fashion after a displacement in the direction of the safety outlet.

35. The cylinder unit as claimed in claim 33, having an operating mode where the second piston is displaceable along the adjustment axis by at least one of a fluid of the first working chamber and of the second working chamber, and wherein the first and the second safety chamber are empty of fluid.

36. The cylinder unit as claimed in claim 33, wherein the first and the second safety chamber are configured to be filled with compressed air.

37. The cylinder unit as claimed in claim 16, wherein each actuating element has a restoring element which is preloaded and which acts on the actuating element such that the restoring element is displaced into the position in which the restoring element blocks the working port and opens up the safety port.

38. The cylinder unit as claimed in claim 37, wherein a control force which acts counter to the force of the restoring element can be applied to an actuating element, and wherein, if the control force prevails, the actuating element is configured to be moved into the position in which the actuating element blocks the safety outlet and opens up the working port.

39. The cylinder unit as claimed in claim 37, wherein the safety outlet is configured to be closed off, and wherein the safety outlet is closed off when the actuating elements block the safety ports.

40. The cylinder unit as claimed in claim 16, wherein a blocking unit is provided for securing the rod in the zero position.

41. The cylinder unit as claimed in claim 40, wherein the blocking unit is at least one of fixed to the housing and integrated at least in regions into the housing.
